(19) United States
(12) Patent Application Publication
(10) Pub. No.: US 2022/0248131 A1
(43) Pub. Date: Aug. 4, 2022

(54) SOUND ACQUISITION APPARATUS AND SOUND ACQUISITION METHOD

(71) Applicant: Hitachi-LG Data Storage, Inc., Tokyo (JP)

(72) Inventors: Takuya NAKAMICHI, Tokyo (JP); Michio HATAGI, Tokyo (JP); Fumio HARUNA, Tokyo (JP)

(21) Appl. No.: 17/531,829

(22) Filed: Nov. 22, 2021

(30) Foreign Application Priority Data
Feb. 4, 2021 (JP) 2021-016830

(51) Int. Cl. H04R 1/40; H04R 3/00; H04S 7/00

(52) U.S. Cl. CPC H04R 1/406; H04R 3/005; H04S 2400/15; H04S 2400/11; H04S 7/302

(57) ABSTRACT

The audio acquisition apparatus includes: a three-dimensional position acquisition unit configured to acquire a three-dimensional position of an object present in a predetermined region; a three-dimensional position tracking unit configured to track, when a sound emitting body is present in the predetermined area, a three-dimensional position of the sound emitting body; a sound pickup unit configured to pick up a sound emitted from the sound emitting body; a communication unit configured to supply the sound picked up by the sound pickup unit to an external apparatus and receive information supplied from the external apparatus; and a sound pickup control unit configured to three-dimensionally follow a sound pickup direction of the sound acquired through the sound pickup unit in accordance with the tracking executed by the three-dimensional position tracking unit.

### CROSS-REFERENCE TO RELATED APPLICATION

The present application claims priority from Japanese application JP2021-016830, filed on Feb. 4, 2021, the contents of which is hereby incorporated by reference into this application.

### BACKGROUND OF THE INVENTION

### 1. Field of the Invention

The present invention relates to a sound acquisition apparatus and a sound acquisition method. Non-limitingly concerned, the invention relates to a sound acquisition apparatus and a sound acquisition method that add a sound tracking function to a digital signage for an interactive service.

### 2. Description of the Related Art

In recent years, a digital signage, which is capable of implementing an unmanned service at a window and providing useful information to a user, has been attracting attention. In the digital signage, it is desirable not only to be capable of providing the useful information to the user but also to be capable of implementing interactive service provision, execution, and the like in order to transmit and receive bidirectional information to and from the user. Further, as a method for implementing such interactive service provision and the like, a method for inputting a sound from the user (hereinafter, also referred to as a “speaker”) has been attracting attention.

In a digital signage based on the sound, it is necessary to determine, by recognizing a sound received from a microphone or the like, a sound uttered by the speaker and thus desired information, and to present optimum information. At this time, a plurality of persons may be present around the digital signage. Accordingly, in this case, if which user is speaking is capable of being identified, the useful information adapted to that user is capable of being presented.

For example, in a camera microphone apparatus for a video conference described in JP-A-2012-147420, a sound collection direction of a microphone is determined, by detecting a position of a person based on an image captured by a camera, to specify who is speaking.

Meanwhile, a person may view the digital signage while moving in a place where there is a large flow of persons such as a station or a shopping center. Therefore, the digital signage needs to acquire the sound correctly even when the speaker speaks while moving, when the speaker speaks while moving between the front and rear non-speakers, or when a plurality of persons near the digital signage move while speaking at the same time and exchange positions. Further, it is necessary to accurately extract only the sound of the speaker even in a noisy environment such as a crowd or a construction site.

However, a technique described in JP-A-2012-147420 has a problem that, when the speaker moves, it is not possible to determine that sounds before and after movement are uttered by the same person.

The present inventor has made intensive studies, has found that the above-mentioned problems are capable of being solved by constructing a mechanism for image recognition and sound extraction using three-dimensional position information, and has completed the invention.

### SUMMARY OF THE INVENTION

An object of the invention is to provide a sound acquisition apparatus and a sound pickup control method that are capable of extracting a sound of a moving sound emitting body with high accuracy.

A sound acquisition apparatus according to an aspect of the invention includes: a sound pickup unit; a three-dimensional position acquisition unit configured to acquire a three-dimensional position of an object present in a predetermined region; a three-dimensional position tracking unit configured to track, when a sound emitting body is present in the predetermined region, a three-dimensional position of the sound emitting body; and a sound pickup control unit configured to three-dimensionally follow a sound pickup direction of a sound acquired through the sound pickup unit in accordance with the tracking executed by the three-dimensional position tracking unit.

A sound pickup control method according to another aspect of the invention includes: acquiring a three-dimensional position of an object present in a predetermined region; tracking, when a sound emitting body is present in the predetermined region, a three-dimensional position of the sound emitting body; and executing control to three-dimensionally follow a sound pickup direction of a sound in accordance with the tracking.

According to the invention, since the sound pickup direction (that is, a sound pickup axis) three-dimensionally moves in accordance with the three-dimensional position of the moving sound emitting body, it is possible to improve processing such as sound acquisition and thus sound recognition when, for example, a human speaks while moving. Therefore, according to the invention, a sound of a moving speaker is capable of being extracted with higher accuracy. Since a sound tracking function is capable of being added to an external apparatus such as a connected digital signage, the effectiveness of an interactive operation executed by such an external apparatus (digital signage or the like) is capable of being improved.

### BRIEF DESCRIPTION OF THE DRAWINGS

FIG. 1 is a diagram illustrating an example of a hardware configuration of a sound acquisition apparatus according to embodiments.

FIG. 2 is a functional block diagram illustrating configurations of a sound acquisition apparatus, a peripheral device thereof, and an external device according to a first embodiment.

FIG. 3 is a flowchart illustrating an operation example of a person position tracking unit provided in the sound acquisition apparatus.

FIG. 4 is a functional block diagram illustrating a configuration of a sound acquisition apparatus and the like according to a second embodiment.

FIG. 5 is a functional block diagram illustrating a configuration of a sound acquisition apparatus and the like according to a third embodiment.

FIG. 6 is a flowchart illustrating operations of a person position tracking unit and a person feature detection unit according to the third embodiment.

### DESCRIPTION OF THE PREFERRED EMBODIMENTS

Hereinafter, regarding an embodiment of the invention, a plurality of embodiments of the invention will be described in detail with reference to the drawings. Sound acquisition apparatus according to the embodiments described later is assumed to be provided in a facility (for example, a store or a station) for which an agreement for imaging and sound collection for a purpose of identifying a person is acquired.

Such a sound acquisition apparatus is connected to a digital signage, and is capable of being used as an apparatus that supports or improves the effectiveness of transmitting and receiving bidirectional information to and from a user by adding a sound tracking function to the digital signage.

However, the sound acquisition apparatus is technically not limited to the above, and is capable of being connected to any apparatus other than the digital signage, and in particular, to an apparatus that performs an interactive operation (for example, an interactive robot or various devices for nursing care). Alternatively, the sound acquisition apparatus may be used alone.

To be briefly described, in order to implement more accurate sound acquisition or sound recognition, the sound acquisition apparatus according to the present embodiment includes: a sound pickup unit such as a microphone configured to pick up a sound; a three-dimensional position acquisition unit configured to acquire a three-dimensional position of an object present in a predetermined region; a three-dimensional position tracking unit configured to track, when a sound emitting body is present in the predetermined region, a three-dimensional position of the sound emitting body; and a sound pickup control unit configured to three-dimensionally follow a sound pickup direction or an extraction direction (that is, a sound pickup axis) of the sound acquired through the microphone and the like (sound pickup unit) in accordance with the tracking executed by the three-dimensional position tracking unit. The sound acquisition apparatus further includes a communication unit configured to supply the sound picked up by the sound pickup unit to an external apparatus (digital signage or the like) configured to provide an interactive service and to receive information supplied from the external apparatus (digital signage or the like).

In the above description, the “sound emitting body” is basically assumed to be a human, but is not limited thereto, and may be another organism that is capable of speaking a human language, such as a parrot. Further, the “sound emitting body” may be some apparatus (inanimate object) that is capable of emitting the sound and moving, such as an autonomous or nursing care robot or drone. Further, the “sound emitting body” is not limited to an autonomously movable organism or inanimate object, and may be, for example, a portable terminal carried by the human or a speaker provided on a road.

However, if all examples are to be described, a text will be complicated and enormous. Therefore, a configuration example in which only the human is exemplified as the “sound emitting body” will be described below.

In the above description, the “predetermined region” is basically assumed to be the facility (for example, the store or the station) for which the agreement for imaging and sound collection for the purpose of identifying the person is acquired as described above, but is of course technically not limited to thereto. In the following description, it is assumed that “in a predetermined region” is “in a captured image” obtained by capturing an image of the inside of the above-mentioned facility.

A more specific configuration example of the sound acquisition apparatus may include a three-dimensional imaging unit such as a stereo camera that is capable of acquiring three-dimensional information for each frame. In this case, the sound pickup unit (microphone or the like) picks up a sound generated in an imaging region of the three-dimensional imaging unit, and the three-dimensional position tracking unit tracks the three-dimensional position of the sound emitting body (human) in an image captured by the three-dimensional imaging unit.

In general, many digital video cameras that are capable of acquiring the three-dimensional information acquire the three-dimensional information for each image (frame). In this case, the three-dimensional position tracking unit tracks the three-dimensional position of the sound emitting body (human) in the image captured by the three-dimensional imaging unit for each frame.

As a configuration example corresponding to a case in which a plurality of sound emitting bodies (humans) are present in the image, an ID is assigned to each of the humans present in the image, and the three-dimensional position of each human having the assigned ID is tracked by the three-dimensional position tracking unit.

In this case, the sound pickup control unit executes control to three-dimensionally follow the sound pickup direction of the sound pickup unit in a direction corresponding to the three-dimensional position of each ID. In one specific example, the sound pickup direction of the sound is three-dimensionally followed by changing a weighting of an orientation of the sound pickup unit (microphone or the like) in accordance with the above-described tracking. In this case, as a specific example of the sound pickup unit, for example, the microphone array may be used that is capable of separately controlling a plurality of orientations (sound pickup directions).

According to the above-mentioned configuration, it is possible to acquire, for each individual human (independently), sounds that are emitted simultaneously from a plurality of humans (sound emitting body) at the same time. In the present embodiment, since a control related to the sound pickup is executed using the three-dimensional information, as compared with a configuration in related art using two-dimensional information as in JP-A-2012-147420, the sound is capable of being extracted and recognized with higher accuracy. Further, by adding the sound tracking function to the digital signage by adopting a configuration that is connected to the digital signage providing the interactive service or a configuration that includes the digital signage, the effectiveness of transmitting and receiving the bidirectional information to and from the user is improved.

Hereinafter, embodiments (first to third embodiments) of the sound acquisition apparatus to which the invention is applied will be described in detail with reference to the drawings.

In the following description, acquisition (pickup or extraction) of the sounds coming from a plurality of directions at once (substantially at the same time) may be referred to as “sound collection”.

### First Embodiment

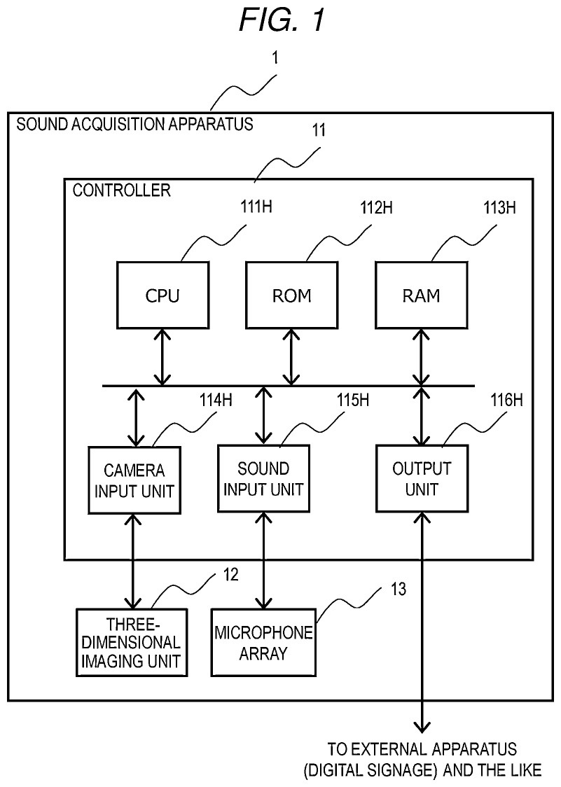

First, a configuration of a sound acquisition apparatus according to a first embodiment will be described with reference to FIGS. 1 to 3. The sound acquisition apparatus according to the first embodiment generally has a configuration of acquiring a three-dimensional position of a speaker (that is, a human) by a three-dimensional imaging unit, tracking the three-dimensional position of the human, dynamically and three-dimensionally determining an orientation (direction of sound pickup or sound collection) of a microphone array according to the tracked three-dimensional position, and picking up or extracting a sound.

FIG. 1 is a diagram illustrating a hardware configuration of a sound acquisition apparatus 1. The sound acquisition apparatus 1 includes a controller 11 as a control unit that controls the entire apparatus. Hardware of the controller 11 includes a central processing unit (CPU) 111H, a read only memory (ROM) 112H, a random access memory (RAM) 113H, a camera input unit 114H, a sound input unit 115H, an output unit 116H, and the like. Specific examples and the like of these blocks will be described later.

As illustrated in FIG. 1, the sound acquisition apparatus 1 includes a three-dimensional imaging unit 12 such as a TOF camera that is connected to the above-mentioned camera input unit 114H in the controller 11 and that is capable of capturing an image of a subject to acquire three-dimensional information of the subject, and a microphone array 13 connected to the sound input unit 115H. Here, the three-dimensional imaging unit 12 and the microphone array 13 are provided such that origins (an imaging element such as a CCD and a sound pickup element such as a diaphragm) are located at the same position.

In the above description, the three-dimensional imaging unit 12 outputs three-dimensional information of a real space to be imaged to the camera input unit 114H. Specifically, the three-dimensional imaging unit 12 is capable of using a stereo camera, a time of flight (TOF) camera, a light detection and ranging (LiDER), a laser pattern depth sensor, or the like.

The three-dimensional imaging unit 12 plays a role of acquiring a three-dimensional position of an object present in a predetermined region (here, an imaging region and thus a captured image), and corresponds to a “three-dimensional position acquisition unit” according to the invention.

In one non-limiting specific example, the three-dimensional imaging unit 12 executes A/D conversion on an analog image signal captured through an optical element such as a lens or an aperture (not illustrated) and the imaging element to convert the analog image signal into digital data, and outputs digital image data to the camera input unit 114H. For example, when the three-dimensional imaging unit 12 is the TOF camera, the three-dimensional information is capable of being acquired, in other words, an image including the three-dimensional information is capable of being captured for each frame by calculating arrival times of infrared light based on images of a plurality of frames obtained by changing emission of the infrared light and an exposure timing of an infrared camera. In the following description, an example is assumed that the TOF camera is used as the three-dimensional imaging unit 12.

The microphone array 13 serving as a sound pickup unit includes a plurality of microphones. In one specific example, the plurality of microphones constituting the microphone array 13 are fixed, and are arranged on a three-dimensional space. In one specific example, the microphone array 13 includes four microphones, two microphones are arranged side by side in a horizontal direction, and the other two microphones are arranged side by side on an upper side or a lower side (a vertical direction) of the two microphones. Each of the plurality of microphones constituting the microphone array 13 picks up a sound, performs the A/D conversion on a picked-up sound signal, and generates and outputs digitized sound data.

The number of microphones constituting the microphone array 13 is not limited to the above, and may be, for example, three or five or more.

The CPU 111H reads and executes various programs stored in the ROM 112H or the RAM 113H. Specifically, a function of each unit of the sound acquisition apparatus 1 is attained by executing the programs by the CPU 111H.

In correspondence relation with the invention, the CPU 111H may have functions of a “three-dimensional position tracking unit”, a “sound pickup control unit”, a “determination unit” or the like. In correspondence relation with each embodiment, the CPU 111H may have functions of a “person position detection unit”, a “person position tracking unit”, a “specific sound extraction unit”, a “generation section detection unit”, a “person feature detection unit” or the like described later in detail.

The ROM 112H is a storage medium that stores the programs to be executed by the CPU 111H and various parameters required for the execution.

The RAM 113H is a storage medium that plays a role of a work area. The work area stores various types of information temporarily used by the CPU 111H. The RAM 113H also functions as a temporary storage region of data to be used by the CPU 111H.

The sound acquisition apparatus 1 may include a plurality of CPUs 111H, a plurality of ROMs 112H, and a plurality of RAMs 113H.

The camera input unit 114H includes an input and output interface (not illustrated) and the like, inputs (acquires) data of the image including the three-dimensional information for each frame from the three-dimensional imaging unit 12 (in this example, the TOF camera), and supplies the data to the CPU 111H or the like. The camera input unit 114H is capable of functioning as the three-dimensional position acquisition unit according to the invention.

The sound input unit 115H includes the input and output interface (not illustrated) and the like, and receives sound data from the microphone array 13. At this time, the sound data to be input has the same number of channels as the number of the microphones of the microphone array 13. The data is capable of being transmitted and received between the sound input unit 115H and the microphone array 13 based on a protocol such as a universal serial bus (USB), an inter-IC sound (I2S), an inter-integrated circuit (I2C), a serial peripheral interface (SPI), and a universal asynchronous receiver transmitter (UART).

The output unit 116H outputs a result processed by the CPU 111H to an external apparatus (for example, a digital signage) or the like. The result processed by the CPU 111H is capable of being stored in the ROM 112H or the RAM 113H.

The hardware configuration of the sound acquisition apparatus 1 is not limited to the configuration illustrated in FIG. 1. For example, the CPU 111H, the ROM 112H, and the RAM 113H may be provided separately from the sound acquisition apparatus 1. In this case, the sound acquisition apparatus 1 may be implemented using a general-purpose computer (for example, a server computer, a personal computer, a smartphone, or the like).

A plurality of computers is capable of being connected to one another via a network, and the computers are capable of sharing the functions of the units of the sound acquisition apparatus 1. On the other hand, one or more functions of the sound acquisition apparatus 1 are capable of being implemented using dedicated hardware.

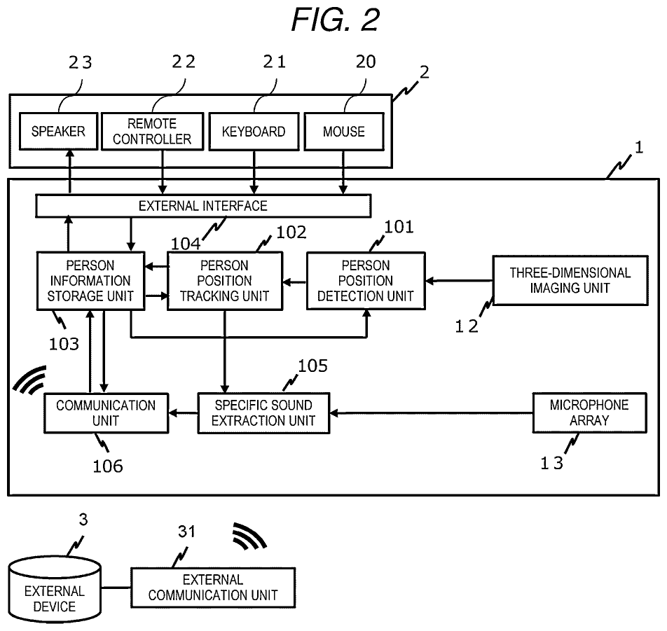

FIG. 2 is a block diagram illustrating functional configurations of the sound acquisition apparatus 1 and a peripheral device thereof. The sound acquisition apparatus 1 is connected to the peripheral device 2 and the external device 3.

The sound acquisition apparatus 1 includes the above-mentioned three-dimensional imaging unit 12 and microphone array 13 in FIG. 1, and a person position detection unit 101, a person position tracking unit 102, a person information storage unit 103, an external interface 104, a specific sound extraction unit 105 and a communication unit 106 as functions of the controller 11 (the CPU 111H or the like) in FIG. 1.

In the above description, the person position detection unit 101 has a function of the “determination unit” that determines the presence or absence of a sound emitting body (human) in an image having image data (in this example, image data for each frame) received from the three-dimensional imaging unit 12. In this example, the person position detection unit 101 determines the presence or absence of a person (a whole figure of the human or a part of a body) in the image acquired from the three-dimensional imaging unit 12.

The person position detection unit 101 has a function of a “position detection unit” that detects a person position (three-dimensional position) on a three-dimensional coordinate (X, Y, Z axes) of the sound emitting body (human) in the image.

In addition, the person position detection unit 101 has a function of transferring the image data received from the three-dimensional imaging unit 12 to the person position tracking unit 102.

Further, the person position detection unit 101 is connected to a person information storage unit 103 that will be described later, and acquires a person position (three-dimensional position) and a corresponding ID for each frame that are supplied from the human information storage unit 103.

The person position tracking unit 102 further transfers the image data for each frame, received from the person position detection unit 101, to the person information storage unit 103, and tracks the person position, that is, the three-dimensional position of the sound emitting body (person) based on the image data and information received from the human information storage unit 103.

The person position tracking unit 102 has a function of assigning an ID to the same sound emitting body (person) in order to deal with a case in which a plurality of sound emitting bodies (humans) are present in the image.

The person position tracking unit 102 corresponds to the “three-dimensional position tracking unit” according to the invention.

The person information storage unit 103 is connected to the person position detection unit 101, the person position tracking unit 102, the external interface 104, and the communication unit 106 that are described above, and transmits and receives signals to and from the connected blocks.

The person information storage unit 103 includes, for example, a memory resource (not illustrated) such as an HDD, stores information related to an image for each frame and the sound emitting body (person), and supplies the information to the person position detection unit 101 and the person position tracking unit 102.

The person information storage unit 103 inputs, via the communication unit 106, a signal derived from a sound picked up by the microphone array 13, and specifically, a signal subjected to predetermined processing by the specific sound extraction unit 105 (see FIG. 2) described later, and outputs the input signal from a speaker 23 of the peripheral device 2 described later via the external interface 104.

Other functions of the person information storage unit 103 will be described later.

In this example, the external interface 104 transmits and receives an electric signal to and from the peripheral device 2 via a wired cable.

As illustrated in FIG. 2, the peripheral device 2 includes a mouse 20, a keyboard 21, a remote controller 22, and a speaker 23. Each block (device) is connected to the external interface 104 and thus to the person information storage unit 103 via the wired cable.

Among these blocks, the speaker 23 is capable of outputting, with the sound, a state and a sound collection result of the sound acquisition apparatus 1 sent from the person information storage unit 103 via the external interface 104. It is desirable to insulate the output sound of the speaker 23 by a sound insulating material or the like such that the output sound of the speaker 23 is not picked up by the microphone array 13.

On the other hand, the remote controller 22, the keyboard 21, and the mouse 20 are capable of executing settings and the like for the sound acquisition apparatus 1 by an input operation executed by a user.

The specific sound extraction unit 105 has a function of extracting a sound in a specific direction (in this example, a direction of the three-dimensional position of the sound emitting body (human)) from the sound received from the microphone array 13, and a function of three-dimensionally following the direction (sound pickup direction) of the sound to be extracted in accordance with movement of the sound emitting body (human).

The specific sound extraction unit 105 has a function as the “sound pickup control unit” according to the invention. The specific sound extraction unit 105 will be described in more detail later.

The communication unit 106 communicates with the external device 3 (see FIG. 2). Generally, the communication unit 106 plays a role of supplying the sound picked up by the microphone array 13 (sound pickup unit) to the external device (external apparatus such as the digital signage) and receiving information supplied from the external device 3.

In the example illustrated in FIG. 2, the communication unit 106 executes wireless communication with an external communication unit 31 of the external device 3. Here, as a communication method of the communication unit 106, for example, wireless communication such as WiFi or Bluetooth (registered trademark) is capable of being used. As another example, the communication unit 106 may communicate with the external device 3 in a wired manner. Thus, the sound acquisition apparatus 1 is capable of transmitting the sound acquired through the microphone array 13 to the external device 3 such as a server via the communication unit 106, and causing the external device 3 to execute sound recognition or the like.

The external communication unit 31 transmits data received from the communication unit 106 to the external device 3. The data received by the external communication unit 31 is, for example, sound data collected by the specific sound extraction unit 105. A function of the external device 3 may be provided in the sound acquisition apparatus 1.

The external device 3 is preferably a digital signage that provides an interactive service. A non-limiting example of the interactive service is to recognize a sound of the speaker and respond to the recognized sound. As a simple example, a service is listed that, when the speaker speaks (questions) “what time is it now?”, a current time is output as the image or the sound from the digital signage. Further, for example, a service is listed that, when the speaker asks “would you like to go to XX station?”, “please take the rapid train bound for XX at XX on Platform XX” or the like is output as the image or the sound from the digital signage.

Since a configuration of the digital signage is well known, a detailed description thereof will be omitted. The external device 3 may be various apparatuses other than the digital signage as long as the apparatus executes an interactive operation.

The person position detection unit 101 detects the position of the person based on the image data and the three-dimensional information (hereinafter, the image data and the three-dimensional information of the subject may be collectively referred to as “three-dimensional image data”) of the subject that are acquired from the three-dimensional imaging unit 12. As a method for detecting the position of the person by the person position detection unit 101, for example, pattern matching or deep neural network is capable of being used. At this time, apart or an object to be detected as the person may be a whole body or a part (for example, only a face) of the body. The person position detection unit 101 transmits, to the person position tracking unit 102, a coordinate of the detected position of the person, and three-dimensional or two-dimensional image data obtained by cutting out the person (only the whole body or only the face portion) from the three-dimensional image data acquired from the three-dimensional imaging unit 12.

The person position tracking unit 102 determines, based on the position information of the person detected by the person position detection unit 101 and the three-dimensional image data (for example, the image data obtained by cutting out only the person portion from the three-dimensional data) derived from the three-dimensional imaging unit 12, whether a person detected in a current frame is the same as a person detected in the immediately preceding frame (hereinafter, referred to as a “previous frame”).

The person position tracking unit 102 calculates, for example, a distance between a person position detected in the current frame and a person position detected in the previous frame, and determines that persons having the shortest distance from each other are the same person, thereby executing processing of tracking positions of the same person (hereinafter, referred to as “person position tracking”) in a plurality of frames.

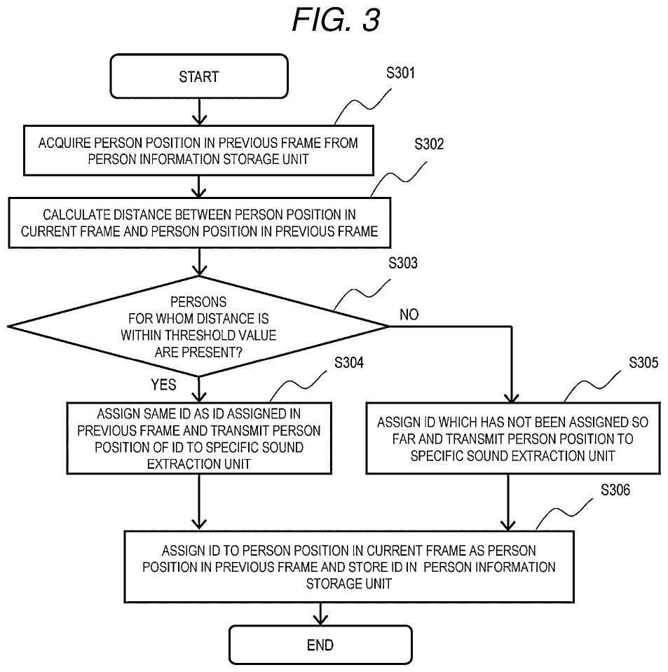

FIG. 3 is a flowchart illustrating a flow of the processing of the “person position tracking” executed by the person position tracking unit 102 according to the above-mentioned method.

In step 301, the person position tracking unit 102 acquires, from the person information storage unit 103, the person position detected in the previous frame by the person position detection unit 101. Here, if the person position in the previous frame is not stored in the person information storage unit 103 (for example, in the first frame), the person position tracking unit 102 determines that the person position is not present in the previous frame.

In step 302, the person position tracking unit 102 compares the person position in the current frame with the person position in the previous frame, and calculates the distance between the person positions.

At this time, if, for example, one person position is present in the previous frame (that is, one human is present in the image), but a plurality of person positions are present in the current frame (that is, a plurality of humans are present in the image), the person position tracking unit 102 compares the person position in the previous frame with each of the person positions in the current frame, and calculates a distance between the person position (of one person) in the previous frame and each of a plurality of person positions in the current frame. Therefore, if n person positions are present in the current frame, n distances are calculated.

For example, if m person positions are present in the previous frame (m persons are present in the image), and n person positions are present in the current frame (n persons are present in the image), the person position tracking unit 102 compares each of the person positions in the current frame with each of the person positions in the previous frames, and calculates distances between persons who are close to each other. In this case, if m>n, n distances are calculated.

In step 303, the person position tracking unit 102 determines the presence or absence of persons for whom the distance (in a case of a plurality of persons, the distances among the plurality of person positions) between the person positions in two frames calculated as described above is within a threshold value.

Here, a specific example of the threshold value may be a limit distance (longest movement distance) at which the human is capable of moving between two successive frames.

Then, if the person position tracking unit 102 determines that persons for whom the above-mentioned distance is within the threshold value are present (YES in step 303), the person position tracking unit 102 determines that the persons are the same person, and the process proceeds to step S304.

On the other hand, if the person position tracking unit 102 determines that no persons for whom the above-mentioned distance is within the threshold value are present (NO in step 303), the person position tracking unit 102 determines that the same person is not present between the current frame and the previous frame, and the process proceeds to step S305.

In step 304, the person position tracking unit 102 assigns the same ID as an ID assigned in the previous frame to the person in the current frame, and transmits the ID and the corresponding person position to the specific sound extraction unit 105.

In step 305, the person position tracking unit 102 assigns a unique ID, which has not been assigned so far, to the person in the current frame, and transmits the ID and the corresponding person position to the specific sound extraction unit 105.

In step 306, the person position tracking unit 102 assigns an ID to the person position in the current frame as person information in the previous frame, and stores the person information in the person information storage unit 103.

If there is a person who has an ID that is present in the previous frame but is not present in the current frame, the person position tracking unit 102 transmits this ID (an ID of a person who is not present in the current frame, hereinafter, referred to as a “disappearance ID”) to the specific sound extraction unit 105. The person position tracking unit 102 deletes, from the person information storage unit 103, a corresponding person position of the ID after the transmission of the disappearance ID.

Another method for determining whether the persons are the same person is also provided. In this method, feature amounts of the face and the body are compared to determine whether the persons are the same person. When adopting this method, the person position detection unit 101 adds, as person information, features of the face and the body parts and information of a distance between the face and the body parts. At this time, the person position tracking unit 102 stores, in the person information storage unit 103, the person information to which the features of the face and the body parts and the information of a distance between the face and the body parts are added. The person position tracking unit 102 regards, as the same person, persons for whom a residual sum of squares between the feature amounts of the face and the body parts in the current frame and the feature amounts of the face and the body parts in the previous frame, or a residual sum of squares between the information of a distance between the face and body parts in the current frame and the information of a distance between the face and body parts in the previous frame is the smallest.

As described above, if a method of comparing the feature amounts of a part of the body is adopted, for example, in a case in which a person, who appears in the previous frame but does not appear in the current frame, appears again in a frame after the current frame, it is easy to determine that the persons (that is, the persons in temporally dispersed frames) are the same person.

Based on the person position of the person information storage unit 103, the person position detection unit 101 is also capable of determining an area to be intensively detected in the three-dimensional image data acquired from the three-dimensional imaging unit 12. Specifically, based on a frame rate and a moving speed of the person, an area between the previous frame and the current frame is understood in which a person is likely to be present. By intensively searching such an area by the person position detection unit 101, the processing amount of the person position detection unit 101 is capable of being reduced.

The specific sound extraction unit 105 determines a direction of extracting (collecting) the sound based on the person position and the ID that are transmitted from the person position tracking unit 102, extracts the sound from an output signal of the microphone array 13, and transmits information including the extracted sound to the communication unit 106.

More specifically, since positions of the plurality of microphones provided in the microphone array 13 are different from one another, arrival time differences of the sounds collected by the microphones are generated. The specific sound extraction unit 105 forms an orientation using these arrival time differences. At this time, by providing a margin (weighting) to the orientation, the specific sound extraction unit 105 is capable of correctly picking up or collecting (extracting the sound) the sound even when the speaker moves between the previous frame and the current frame.

Based on the signal received from the microphone array 13 and the person ID and the person position information that are acquired from the person position tracking unit 102, the specific sound extraction unit 105 continuously picks up (collects) or extracts a sound in a person position transmitted in the previous frame from the previous frame to the current frame. A plurality of person positions may be transmitted.

If the specific sound extraction unit 105 receives, from the person position tracking unit 102, a person position to which the same ID as in the previous frame is assigned in the current frame, the specific sound extraction unit 105 changes a sound pickup direction of the corresponding ID in the previous frame, and continues to extract or collect the sound.

If the specific sound extraction unit 105 receives, from the person position tracking unit 102, a person position to which a new ID is assigned, the specific sound extraction unit 105 adds a new direction (sound pickup direction) corresponding to the person position, and extracts or collects sounds coming from a plurality of directions.

On the other hand, if the specific sound extraction unit 105 receives the above-mentioned “disappearance ID” from the person position tracking unit 102, the specific sound extraction unit 105 stops extracting or collecting a sound from a direction of a person position corresponding to this ID.

As described above, in the first embodiment, the three-dimensional position of the speaker is acquired, the three-dimensional position is tracked, and the control is executed to three-dimensionally follow the sound pickup (sound collection) direction in accordance with the tracked three-dimensional position. According to the first embodiment, even when the speaker speaks while moving, the sound is capable of being correctly collected for the same person.

According to the first embodiment having the above-mentioned configuration, it is possible to acquire, for each individual person, sounds that are emitted simultaneously and frequently from a plurality of humans present in a predetermined region. According to the first embodiment, since the control related to the sound pickup (sound collection) is executed using the three-dimensional information, as compared with a configuration in related art using two-dimensional information as in JP-A-2012-147420, the sound is capable of being extracted and recognized with higher accuracy. Therefore, according to the first embodiment, a sound of a moving human is capable of being extracted with higher accuracy, and thus the effectiveness of the interactive operation is capable of being improved.

### Second Embodiment

In a second embodiment, a configuration example in which a voice detection unit is additionally provided based on the configuration of the sound acquisition apparatus 1 according to the first embodiment will be described. Those having the same configuration and function as in the first embodiment are denoted by the same reference numerals, and the detailed description thereof is omitted.

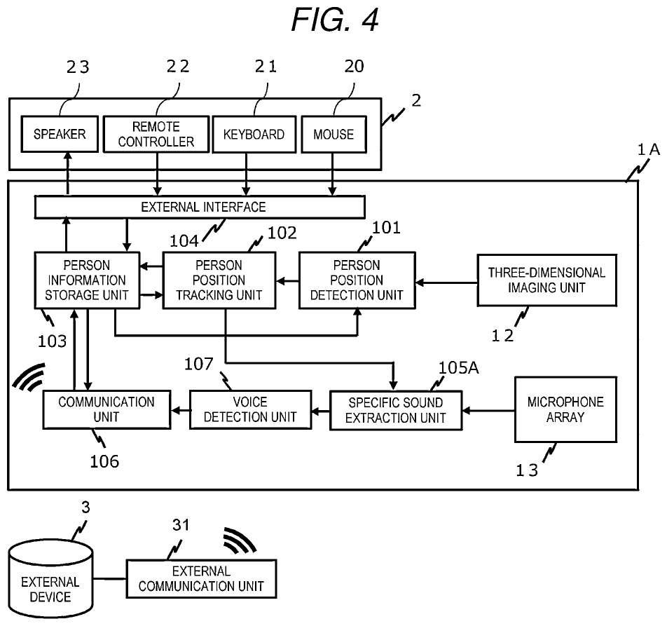

FIG. 4 is a functional configuration diagram illustrating a sound acquisition apparatus 1A according to the second embodiment including a voice detection unit 107. As illustrated in FIG. 4, in the sound acquisition apparatus 1A, the voice detection unit 107 is connected to a front section of the communication unit 106 and a rear section of the specific sound extraction unit 105. Therefore, in the second embodiment, since the function of the specific sound extraction unit 105 is slightly different from that in the first embodiment, the specific sound extraction unit 105 is hereinafter referred to as a specific sound extraction unit 105A using a similar reference numeral.

The specific sound extraction unit 105A according to the second embodiment is the same as the specific sound extraction unit 105 according to the first embodiment in basic functions. The specific sound extraction unit 105A according to the second embodiment three-dimensionally follows a sound pickup direction (a direction of acquiring or extracting the sound) in accordance with a person position and an ID that are transmitted from the person position tracking unit 102, and collects or extracts sounds from one or more specific directions.

On the other hand, the specific sound extraction unit 105A transmits information including the sound collected from the specific direction to the voice detection unit 107 instead of the communication unit 106 (see FIG. 4). Similar to the first embodiment, information output from the specific sound extraction unit 105A may be transmitted to the communication unit 106, and in this case, such information may be transmitted (transferred) via the voice detection unit 107.

The voice detection unit 107 extracts only a portion that is likely to be spoken by a human from the sounds extracted (collected) by the specific sound extraction unit 105A (detects a component), and transmits information including the detected sound to the communication unit 106. Specific examples of a method for detecting the component that is likely to be a speech of the person includes extracting a sound that includes a specific frequency band and whose sound volume in this frequency band is a certain value (predetermined threshold value) or more. Here, the specific frequency band is, for example, 10 Hz to 1000 Hz uttered by the person. In this case, the voice detection unit 107 cuts (filters) a frequency band of less than 10 Hz and a frequency band of 1001 Hz or more from the sounds extracted (collected) by the specific sound extraction unit 105A, and transmits a sound signal after the filtering to the communication unit 106.

Deep learning is also capable of being used as another method for extracting a portion that is likely to be the speech of the person by the voice detection unit 107. When using the deep learning, the portion that is likely to be the speech of the person is capable of being extracted by causing a deep neural network to learn the speeches of a plurality of persons in advance. Further, it is also possible to extract a sound of only a specific person by learning only the speech of the specific person.

According to the sound acquisition apparatus 1A in the second embodiment, in addition to above-mentioned effects based on the configuration according to the first embodiment, it is possible to extract only the sound of the person with higher accuracy from the sounds at a position where the person is present. Accordingly, for example, when sound recognition is executed by the external device 3 (for example, a cloud server), the sound recognition accuracy is capable of being improved, and thus the effectiveness of the interactive operation is capable of being improved.

The voice detection unit 107 may be provided in a rear section of the microphone array 13 and a front section of the specific sound extraction unit 105A.

### Third Embodiment

In a third embodiment, an example in which the person feature detection unit is provided based on the configuration of the sound acquisition apparatus 1A according to the second embodiment will be described. Those having the same configuration and function as in the first embodiment and the second embodiment are denoted by the same reference numerals, and the detailed description thereof is omitted.

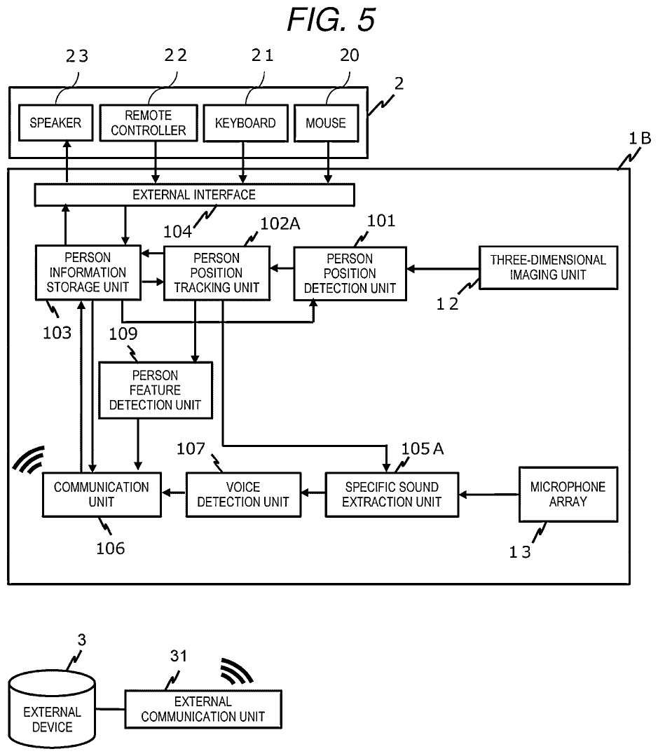

FIG. 5 is a block diagram illustrating a configuration of a sound acquisition apparatus according to the third embodiment. As is clear based on comparison with FIG. 4 (the second embodiment), a sound acquisition apparatus 1B according to the third embodiment illustrated in FIG. 5 has a configuration in which a person feature detection unit 109 is additionally provided with respect to the sound acquisition apparatus 1A according to the second embodiment.

The person feature detection unit 109 is connected to the person position tracking unit 102 and the communication unit 106. Therefore, in the third embodiment, since the function of the person position tracking unit 102 is slightly different from that according to the first embodiment and the second embodiment, the person position tracking unit 102 is hereinafter referred to as a person position tracking unit 102A using a similar reference numeral.

Similarly to the person position tracking unit 102 according to the first embodiment or the second embodiment, the person position tracking unit 102A determines, based on position information of a person detected by the person position detection unit 101 and three-dimensional image data (for example, image data obtained by cutting out only a person portion) derived from the three-dimensional imaging unit 12, whether a person detected in a current frame is the same as a person detected in a previous frame (immediately preceding frame). This determination method and the feature of executing tracking by assigning the ID to each same person are similar as described above.

On the other hand, in the third embodiment, the person position tracking unit 102A transmits information including the person position, to which the ID is assigned, to the specific sound extraction unit 105A, and also to the person feature detection unit 109 (see FIG. 5).

In one specific example, the person position tracking unit 102A transmits, to the person feature detection unit 109, information to which three-dimensional image data (which may be two-dimensional image data from the viewpoint of rapid processing or the like) is added. The three-dimensional image data is obtained by cutting out only the person portion or only the face portion of the person from the three-dimensional image data acquired from the three-dimensional imaging unit 12 by the person position detection unit 101. Hereinafter, a case will be described in which the information is received by the person feature detection unit 109 in order to more accurately estimate a feature of the person. The three-dimensional image data is added to the information.

The person feature detection unit 109 estimates a feature (for example, height, sex, age, and facial expression) of the speaker based on three-dimensional image data that is obtained by cutting out only the person portion or only a face portion of the person and that is received from the person position tracking unit 102A. Here, as a method for estimating the sex, age, and facial expression of the person by the person feature detection unit 109, for example, deep learning (learned data) is capable of being used. In the deep learning, even, for example, when the three-dimensional image data of only the person portion is used, according to the present embodiment in which the three-dimensional information is used for learning, a feature of this person is capable of being more accurately estimated as compared with a case in which the feature is estimated using the two-dimensional information.

On the other hand, if the person feature detection unit 109 estimates the height of the person, the height of the person is capable of being estimated relatively easily based on a three-dimensional position of the face of the person, without using the deep learning. In this case, a more accurate value is capable of being estimated as compared with a case in which the height of the person is estimated using the two-dimensional information.

The person feature detection unit 109 is also capable of authenticating an individual based on the above-mentioned three-dimensional image data. Here, the deep learning (learned data) is capable of being used as a method for individual authentication executed by the person feature detection unit 109.

Specifically, the person feature detection unit 109 extracts feature amounts of the face and the body of the person based on the above-mentioned three-dimensional image data. The person feature detection unit 109 is set to a state in which the feature amounts of the face and the body of the individual to be authenticated are capable of being calculated in advance and a calculation result is capable of being used (read and the like) as learned data. The feature amounts (learned data) calculated in advance is stored in the person feature detection unit 109 (RAM 113H in FIG. 1 in terms of hardware). The feature amounts may be calculated by another block of the sound acquisition apparatus 1B or may be calculated by the external device 3. Alternatively, the above-mentioned feature amounts (learned data) are also capable of being input using the peripheral device 2 including the mouse 20, the keyboard 21, and the like described above with reference to FIG. 2.

In the above-mentioned configuration, the person feature detection unit 109 compares the extracted feature amounts with the feature amounts (learned data) calculated in advance. If a comparison result is a threshold value or less, or the threshold value or more, the person feature detection unit 109 determines (authenticates) that individuals are not different.

When the person feature detection unit 109 receives, from the person position tracking unit 102A, information including a sound having an ID that has not been used so far, the feature amounts are capable of being calculated in advance and stored in the person feature detection unit 109 (RAM 113H). With such a configuration, it is possible to reduce a load on a processor or the like and save a memory resource.

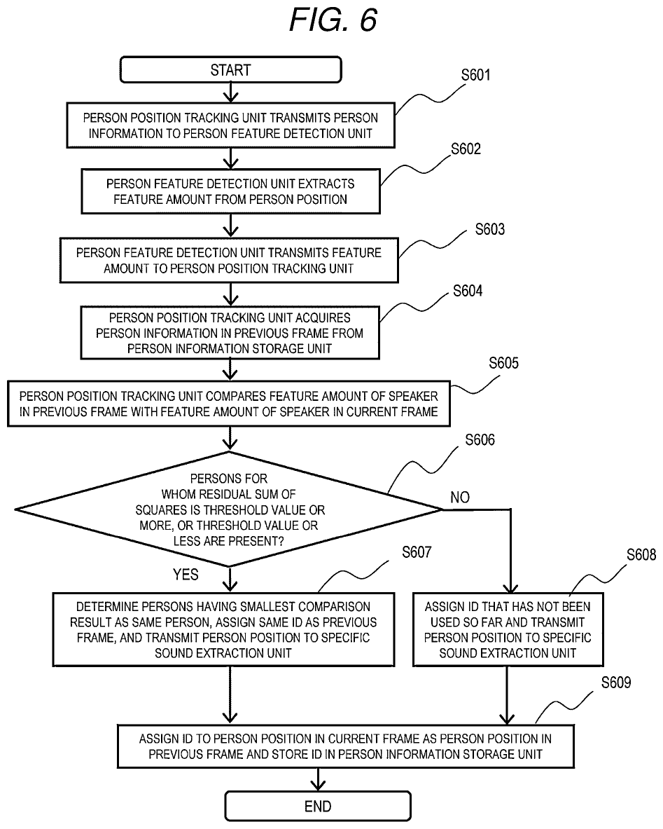

The person position tracking unit 102A may execute tracking based on a detection result obtained by the person feature detection unit 109. FIG. 6 is a flowchart illustrating a specific example of such processing. Hereinafter, processing performed by the person position tracking unit 102A and the person feature detection unit 109 in cooperation with each other will be described with reference to FIG. 6.

In step 601, the person position tracking unit 102A transmits, to the person feature detection unit 109, person information including the three-dimensional (which may be two-dimensional, the same applies hereinafter) image data. The three-dimensional image data is transmitted from the person position tracking unit 102A, and is obtained by cutting out only the person portion or only the face portion of the person from the three-dimensional image data acquired from the three-dimensional imaging unit 12 by the person position detection unit 101.

In step 602, the person feature detection unit 109 extracts a feature amount of the speaker from the person information transmitted from the person position tracking unit 102A.

In step 603, the person feature detection unit 109 transmits the extracted feature amount to the person position tracking unit 102A.

In step 604, the person position tracking unit 102A acquires person information in the previous frame from the person information storage unit 103. The person information in the previous frame includes information of a feature amount extracted by the person feature detection unit 109 in the previous frame.

In step 605, the person position tracking unit 102A compares the feature amount of the speaker included in the person information in the previous frame with the feature amount extracted by the person feature detection unit 109 in the current frame. For this comparison, a residual sum of squares is capable of being used. In this case, if a residual sum of squares between the feature amount in the previous frame and the feature amount in the current frame is the threshold value or more, or the threshold value or less, the person position tracking unit 102A determines that the speaker in the previous frame and the speaker in the current frame are the same person (refer to the branch of step 606).

Then, if the person position tracking unit 102A determines that the speakers are the same person (YES in step 606), the process proceeds to step 607. On the other hand, if the person position tracking unit 102A determines that the speakers are not the same person (NO in step 606), the process proceeds to step 608.

In step 607, the person position tracking unit 102A transmits, to the specific sound extraction unit 105A, an ID and a person position that are included in the person information in the previous frame, and the process proceeds to step 609.

On the other hand, in step 608, the person position tracking unit 102A adds an ID (unique identifier) that has not been used so far and transmits the unique identifier and the person position to the specific sound extraction unit 105A, and the process proceeds to step 609.

In step 609, the person position tracking unit 102A assigns an ID to the person information in the current frame as the person information in the previous frame, and stores these pieces of information in the person information storage unit 103. At this time, the person position tracking unit 102A also stores, in the person information storage unit 103, the feature amount of the speaker in the current frame extracted by the person feature detection unit 109.

The above-mentioned processing in step 604 (acquisition of the person information) may be executed before step 601 or at any timing from step 601 to step 605.

According to the above-mentioned third embodiment, in addition to the above-mentioned effects according to the first embodiment and the second embodiment, the feature (height, sex, age, facial expression, and the like) of the speaker is capable of being acquired.

Therefore, for example, even when the same person goes in and out many times in an image captured by the three-dimensional imaging unit 12, it is possible to quickly determine (or authenticate) that the persons are the same person.

For example, even when the speaker is a young boy who is lost and crying, it is possible to quickly understand this feature by the sound acquisition apparatus 1B, the external device 3, or the like. If a digital signage is connected to the sound acquisition apparatus 1B as the external device 3, the effectiveness of an interactive operation is capable of being further improved by outputting the sound such as “are you lost?” from the digital signage.

The invention is not limited to the above-mentioned embodiments, and includes various modifications. For example, the above-mentioned embodiments have been described in detail for easy understanding of the invention, and are not necessarily limited to those including all the configurations described above. A part of a configuration according to an embodiment may be replaced with a configuration according to another embodiment, or a configuration according to an embodiment may be added to a configuration according to another embodiment. It is possible to add, delete, or replace other configurations for a part of a configuration according to each embodiment.

For example, in each of the above-mentioned embodiments, a configuration is assumed in which the plurality of microphones are fixed, but the invention is not limited to such a configuration. As another configuration example, a configuration may be adopted in which a plurality of microphones having a single orientation are used and control for moving each of the microphones is executed such that the sound pickup direction of the microphone is moved in accordance with the movement of each sound emitting body.

What is claimed is:

1. A sound acquisition apparatus comprising:
a sound pickup unit;
a three-dimensional position acquisition unit configured to acquire a three-dimensional position of an object present in a predetermined region;
a three-dimensional position tracking unit configured to track, when a sound emitting body is present in the predetermined region, a three-dimensional position of the sound emitting body; and
a sound pickup control unit configured to three-dimensionally follow a sound pickup direction of a sound acquired through the sound pickup unit in accordance with the tracking executed by the three-dimensional position tracking unit.

2. The sound acquisition apparatus according to claim 1, in order to add a sound tracking function to an external apparatus configured to provide an interactive service, further comprising:
a communication unit configured to supply the sound picked up by the sound pickup unit to the external apparatus and receive information supplied from the external apparatus.

3. The sound acquisition apparatus according to claim 1, wherein
the sound pickup unit is a microphone array in which a plurality of microphones are three-dimensionally arranged, and
the sound pickup control unit three-dimensionally follows the sound pickup direction of the sound by changing a weighting of an orientation of the microphone array in accordance with the tracking.

4. The sound acquisition apparatus according to claim 1, wherein
the sound emitting body is a human,
the sound acquisition apparatus further comprises a person position detection unit configured to detect a position on a three-dimensional coordinate of a whole body or a part of a body of a human as the sound emitting body in the predetermined region, and
the three-dimensional position tracking unit tracks a three-dimensional position of the human based on a detection result obtained by the person position detection unit.

5. The sound acquisition apparatus according to claim 4, further comprising:
a person feature detection unit configured to estimate a feature of the human from an image of the human detected by the person position detection unit, wherein
the three-dimensional position tracking unit determines whether a person in a current frame and a person in a previous frame are the same person using the feature estimated by the person feature detection unit, and transmits a determination result to the sound pickup control unit.

6. The sound acquisition apparatus according to claim 1, wherein
the three-dimensional position tracking unit tracks the three-dimensional position for each sound emitting body present in the predetermined region, and
the sound pickup control unit increases or decreases the number of the sound pickup directions in accordance with the number of the sound emitting bodies present in the predetermined region.

7. The sound acquisition apparatus according to claim 1, wherein
the three-dimensional position acquisition unit includes a three-dimensional imaging unit configured to capture an image of the predetermined region to acquire three-dimensional information of the object, and
the sound acquisition apparatus further comprises a determination unit configured to determine whether the sound emitting body is present in the image captured by the three-dimensional imaging unit.

8. The sound acquisition apparatus according to claim 7, wherein
the determination unit further determines whether the sound emitting body present in an image of a previous frame captured by the three-dimensional imaging unit is the same as the sound emitting body present in an image of a current frame captured by the three-dimensional imaging unit,
the three-dimensional position tracking unit assigns the same ID to the same sound emitting body, and
the sound pickup control unit increases or decreases the number of the sound pickup directions based on the assigned ID.

9. The sound acquisition apparatus according to claim 6, wherein
the three-dimensional position acquisition unit acquires the three-dimensional position by preferentially searching for a position of the sound emitting body present in the image of the previous frame when acquiring the three-dimensional position of the object present in the image of the current frame.

10. The sound acquisition apparatus according to claim 2, further comprising:
a voice detection unit configured to detect a component of a voice of a person from the sound acquired through the sound pickup unit, wherein
the communication unit transmits the sound detected by the voice detection unit to a digital signage serving as the external apparatus.

11. A sound pickup control method comprising:
acquiring a three-dimensional position of an object present in a predetermined region;
tracking, when a sound emitting body is present in the predetermined region, a three-dimensional position of the sound emitting body; and
executing control to three-dimensionally follow a sound pickup direction of a sound in accordance with the tracking.
